(19) United States
(12) Patent Application Publication
(10) Pub. No.: US 2010/0134235 A1
(43) Pub. Date: Jun. 3, 2010

(54) ESD PROTECTOR AND METHOD OF MANUFACTURING THE SAME

(75) Inventors: Kouichi Yoshioka, Kyoto (JP); Masakatsu Nawate, Osaka (JP); Takashi Morino, Fukui (JP); Kenji Nozoe, Fukui (JP); Takeshi Iseki, Fukui (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/374,559

(22) PCT Filed: Jun. 19, 2008
(86) PCT No.: PCT/JP2008/001582

§ 371 Date: Jan. 21, 2009

(30) Foreign Application Priority Data
Jun. 21, 2007 (JP) 2007-163496
Aug. 24, 2007 (JP) 2007-217946
Aug. 24, 2007 (JP) 2007-217947
Jan. 18, 2008 (JP) 2008-008871
Feb. 27, 2008 (JP) 2008-045407

(51) Int. Cl. H01R 43/00; H01C 7/12

(52) U.S. Cl. 338/21; 29/825

(57) ABSTRACT

A pair of thick first electrodes (2) are formed on an upper surface of alumina substrate (1) are formed with material having a low specific resistance. Thin second electrodes (3) that are positioned between first electrodes (2) and made of material having a high melting point are formed in a thin state. A gap (4) is formed between the second electrodes (3). First electrodes (2) forming connection electrodes are prevented from producing heat and protected from damage. The width of the gap between second electrodes (3) is narrow and accurate. This provides an electrostatic discharge (ESD) protector that is resistant to repetitive application of static electricity, reduces a peak voltage, and has a stable characteristic suppressing electrostatic discharge.

### TECHNICAL FIELD

The present invention relates to an electrostatic discharge (ESD) protector for protecting an electronic apparatus from static electricity, and to a method of manufacturing the ESD protector.

### BACKGROUND ART

Electronic apparatuses, such as portable phones, have recently had small sizes and high performance, and electronic devices used for the electronic apparatuses have accordingly had small sizes. However, as having such small sizes, the electronic apparatuses or electronic devices have their withstanding voltages lowered. Thus, an electrostatic pulse produced upon a human body touching terminals of the electronic apparatuses may often damage electric circuits in the apparatuses. This is because the electrostatic pulse applies high voltages of hundreds to thousands of volts to the electric circuits in the apparatuses at a rising rate less than 1 nanosecond.

In order to protest such an electrostatic pulse, an electrostatic discharge (ESD) protector has been provided between a line receiving static electricity and a ground. As the transmission speed of the signal line has increased over several hundred Mbps, the ESD protector provides a stray capacitance to cause a signal quality to deteriorate, hence having a small stray capacitance preferably. The transmission speed higher than several hundred Mbps requires an ESD protector having a low capacitance less than 1 pF.

As the ESD protector used for such a high-speed transmission line, an ESD protector including electrodes facing each other across a gap and an over-voltage protective layer covering portions of the electrodes have been developed. However, such an ESD protector being resistant to repetitive application of static electricity, reducing a peak voltage, and having stable characteristic for suppressing electrostatic discharge (ESD) can hardly be manufactured.

Conventional art information related to the present invention is disclosed in Patent Document 1.

A cause for the deterioration of the ESD protector or the variation of its characteristics will be described below. A mechanism to exhibit characteristics in the conventional ESD protector including the electrodes facing each other across the gap and the over-voltage protective layer covering the portions of the electrodes will be explained below. When an over voltage produced due to static electricity is applied to the gap between electrodes facing each other, a discharge current flows between conductive particles or between semiconductor particles dispersed in a portion of the over-voltage protective layer located in the gap between the electrodes, and is bypassed to the ground. In this conventional ESD protector, repetitive application of the static electricity deteriorates the characteristic for bypassing the static electricity to the ground. After the static electricity is repetitively applied, the width of the gap between the electrodes becomes slightly larger than the initial state then the ESD protector according to an observation in a non-destructive analysis method with, for example, an X-ray transmission microscope. A reason for this phenomenon is considered that the electrodes are heated by the current flowing during applying of the static electricity, and the heat cause the electrodes to melt slightly and damages the electrodes.

The damage of the electrodes itself is caused mostly by the heat generated by the current flowing in the electrodes mainly when the electrostatic discharge (ESD) is applied. Therefore, in order to reduce the damage of the electrodes, the amount of the heat generated in the electrodes is reduced, and the electrodes are made of material resistant to heat. In this case, in order to suppress the amount of the heat in the electrodes, the electrodes are made of material having a small specific resistance, and have large thicknesses so as to reduce a resistance of the electrodes. The material resistant to heat may be material having a high melting point.

In the case that the thicknesses of the interconnect electrodes are increased in order to reduce the resistance of the electrodes, the gap between the electrodes can hardly be accurately narrow. In that case that the electrodes are made of material, such as tungsten or molybdenum, which is resist to heat and has a high melting point, the material effectively suppresses the damage due to the heat since the material has the melting point higher than that of gold. However, since the surface of the material may be easily oxidized, the material has a large resistance if having a small thickness less than 2 μm. When tungsten or molybdenum has a large thickness in order to prevent the increase of the heat amount, the gap can hardly be accurately narrow similar to above-mentioned reason.

Patent Document 1: JP 2002-538601A

### SUMMARY OF THE INVENTION

An electrostatic discharge (ESD) protector includes an insulating substrate, a pair of first electrodes provided on an upper surface of the insulating substrate, a gap provided between the pair of first electrodes, and an over-voltage protective layer covering the gap. The pair of first electrodes are made of material having a low specific resistance and have large thicknesses. Second electrodes made of material having a high melting point and having small thicknesses are provided between the pair of first electrodes and are electrically connected to the first electrodes, respectively. A gap is provided between the second electrodes.

The pair of first electrodes are made of the material having a low specific resistance and have large thicknesses. This structure reduces the resistances of the pair of first electrodes, and accordingly suppresses heat produced by a current flowing due to static electricity. The second electrodes made of the material having the high melting point have small thicknesses are provided between the pair of first electrodes and are electrically connected to the first electrodes, and provide a gap between the second electrodes. This structure prevents the electrodes from damage due to the static electricity, and allows the gap to have an accurately small width of about 10 μm between the second electrodes. The ESD protector is resistant to repetitive application of static electricity, reduces a peak voltage, and has a stable suppressing characteristic of electrostatic discharge (ESD).

### BRIEF DESCRIPTION OF DRAWINGS

FIG. 1 is a sectional view of an electrostatic discharge (ESD) protector in accordance with Exemplary Embodiment 1 of the present invention.

FIG. 2A is a sectional view of the ESD protector for illustrating a method of manufacturing the ESD protector in accordance with Embodiment 1.

FIG. 2B is a top view of the ESD protector for illustrating the method of manufacturing the ESD protector in accordance with Embodiment 1.

FIG. 3A is a sectional view of the ESD protector for illustrating the method of manufacturing the ESD protector in accordance with Embodiment 1.

FIG. 3B is a top view of the ESD protector for illustrating the method of manufacturing the ESD protector in accordance with Embodiment 1.

FIG. 3C is a sectional view of the ESD protector for illustrating the method of manufacturing the ESD protector in accordance with Embodiment 1.

FIG. 3D is a top view of the ESD protector for illustrating the method of manufacturing the ESD protector in accordance with Embodiment 1.

FIG. 4A is a sectional view of the ESD protector for illustrating the method of manufacturing the ESD protector in accordance with Embodiment 1.

FIG. 4B is a top view of the ESD protector for illustrating the method of manufacturing the ESD protector in accordance with Embodiment 1.

FIG. 4C is a sectional view of the ESD protector for illustrating the method of manufacturing the ESD protector in accordance with Embodiment 1.

FIG. 4D is a top view of the ESD protector for illustrating the method of manufacturing the ESD protector in accordance with Embodiment 1.

FIG. 5A is a sectional view for illustrating the method of manufacturing the ESD protector in accordance with Embodiment 1.

FIG. 5B is a bottom view of the ESD protector for illustrating the method of manufacturing the ESD protector in accordance with Embodiment 1.

FIG. 5C is a sectional view of the ESD protector for illustrating the method of manufacturing the ESD protector in accordance with Embodiment 1.

FIG. 5D is a top view of the ESD protector for illustrating the method of manufacturing the ESD protector in accordance with Embodiment 1.

FIG. 5E is a top view of the ESD protector for illustrating the method of manufacturing the ESD protector in accordance with Embodiment 1.

FIG. 6A is a sectional view of the ESD protector for illustrating the method of manufacturing the ESD protector in accordance with Embodiment 1.

FIG. 6B is a top view of the ESD protector for illustrating the method of manufacturing the ESD protector in accordance with Embodiment 1.

FIG. 6C is a sectional view of the ESD protector for illustrating the method of manufacturing the ESD protector in accordance with Embodiment 1.

FIG. 6D is a top view of the ESD protector for illustrating the method of manufacturing the ESD protector in accordance with Embodiment 1.

FIG. 7A is a sectional view of the ESD protector for illustrating the method of manufacturing the ESD protector in accordance with Embodiment 1.

FIG. 7B is a top view of the ESD protector for illustrating the method of manufacturing the ESD protector in accordance with Embodiment 1.

FIG. 8 schematically illustrates a method of performing an electrostatic test to the ESD protector in accordance with Embodiment 1.

FIG. 9 is a graph showing a result of the electrostatic test of the ESD protector in accordance with Embodiment 1.

FIG. 10 is a sectional view of another ESD protector in accordance with Embodiment 1.

FIG. 11 is a graph showing a result of an electrostatic test of an ESD protector in accordance with Exemplary Embodiment 2 of the present invention.

FIG. 12 is a graph showing a result of an electrostatic test of an ESD protector in accordance with Exemplary Embodiment 3 of the present invention.

REFERENCE NUMERALS

| | |
|---|---|
| 1 | Alumina Substrate |
| 2 | First Electrode |
| 3 | Second Electrode |
| 4 | Gap |
| 7 | Over-Voltage Protective Layer |

### DETAILED DESCRIPTION OF PREFERRED EMBODIMENTS

### Exemplary Embodiment 1

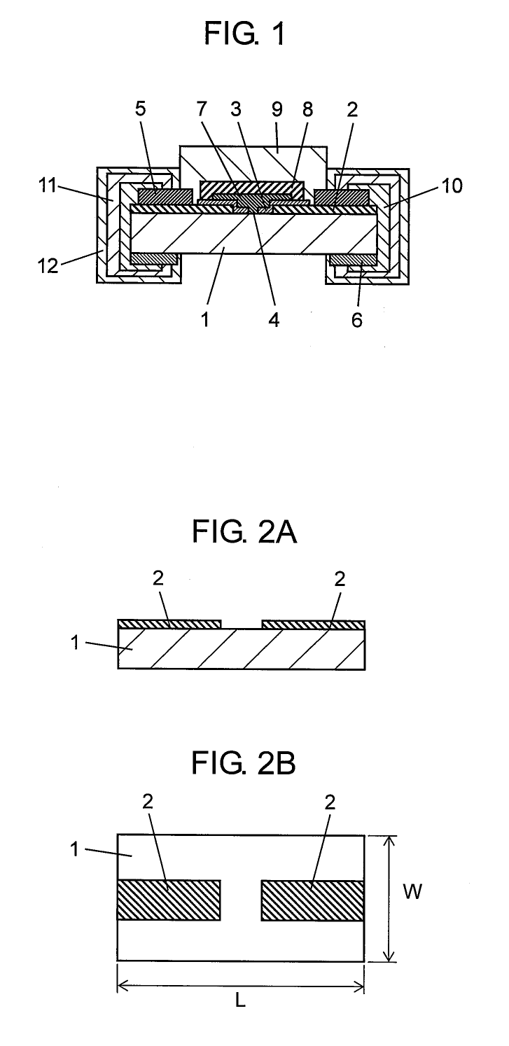

An electrostatic discharge (ESD) protector and its manufacturing method in accordance with Exemplary Embodiment 1 will be described below with reference to accompanying drawings. FIG. 1 is a sectional view of the ESD protector in accordance with Embodiment 1 of the present invention. As shown in FIG. 1, the ESD protector according to Embodiment 1 includes a pair of first electrodes 2 providing connection electrodes on an upper surface of alumina substrate 1. Substrate is an insulating substrate having a relative dielectric constant of 50 or less, preferably 10 or less. Second electrodes 3 are provided between first electrodes 2, partially overlap first electrodes 2, and are electrically connected to first electrodes 2, respectively. Second electrodes 3 are made of material having a high melting point, and have thicknesses smaller than those of first electrodes 2. Gap 4 is provided at a center portion of second electrodes 3 cut with laser. Gap 4 is a narrow space having no electrode. A pair of upper electrodes 5 are formed on first electrodes 2, respectively. A pair of lower electrodes 6 are formed on a lower surface of alumina substrate 1. Over-voltage protective layer 7 containing metal powder and silicone resin covers gap 4 and portions of second electrodes 3. Intermediate layer 8 containing insulator powder and silicone resin is formed on over-voltage protective layer 7. Protective resin layer 9 is formed on intermediate layer 8 so as to entirely cover intermediate layer 8 and to cover portions of upper electrodes 5. Edge electrodes 10 electrically connected to first electrodes 2, upper electrodes 5, and lower electrodes 6 are formed at both ends of alumina substrate 1. Nickel-plated layers 11 and tin-plated layers 12 produced by a barrel plating method are formed so as to cover edge electrodes 10, respectively.

A method of manufacturing the ESD protector according to Embodiment 1 will be described below.

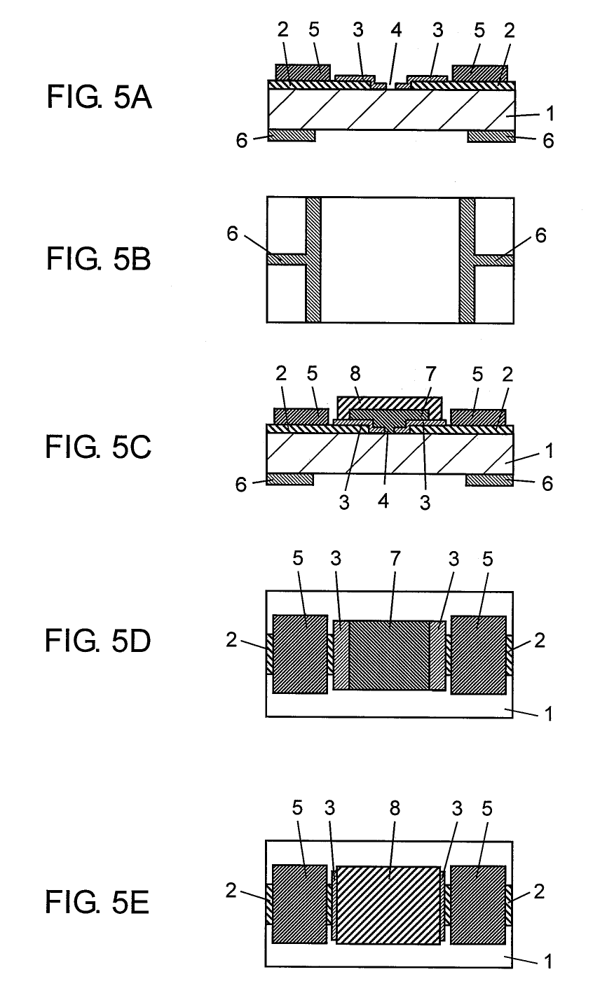

FIGS. 2A and 2B, FIGS. 3A to 3D, FIGS. 4A to 4D, FIGS. 5A to 5E, FIG. 6A to FIG. 6D, and FIGS. 7A and 7B are sectional views, plan views, and a bottom view of the ESD protector for illustrating the method of manufacturing the ESD protector according to Embodiment 1. FIGS. 2A, 3A, 3C, 4A, 4C, 5A, 5C, 6A, 6C, and 7A are sectional views of the individual substrate. FIGS. 2B, 3B, 3D, 4B, 4D, 5D, 5E, 6B, 6D, and 7B are top views of the individual substrate, and FIG. 5B is a bottom view of the individual substrate.

First, as shown in FIGS. 2A and 2B, a pair of first electrodes 2 providing connection electrodes are formed on both ends of an upper surface of alumina substrate 1. Alumina substrate 1 is produced by firing, at a temperature ranging from 900 to 1300° C., alumina having a relative dielectric constant of 50 or less, preferably 10 or less. Since alumina has high heat resistance and high adhesiveness to a function element, the insulating substrate is made of alumina. FIGS. 2A and 2B illustrate alumina substrate 1 having a rectangular shape having long sides of L (mm) and short sides of W (mm), as the size of the individual ESD protector. Individual alumina substrate 1 will be shown in the explanation of processes for manufacturing the ESD protector. In the actual processes, a sheet-like aggregated alumina substrate including a lot of alumina substrates 1 arranged longitudinally and laterally is manufactured, and is divided into strip shapes or chip shapes before a process for forming the edge electrodes, as described later.

First electrodes 2 are patterned as shown in FIG. 2B with material mainly containing gold and having a low specific resistance. In this case, conductive paste mainly containing gold is printed in a strip shape by a screen printing method, and is fired at about 850° C. for 45 minutes, thereby forming first electrodes 2. This method is more preferable in productivity and cost than other gold-based material, such as gold-based spattering. The thickness of first electrode 2 after firing may range from 2 to 20 μm, preferably from 2 to 10 μm. The first electrodes have relatively large thickness to provide the electrodes with stabile and small resistance. First electrode 2 is printed to provide blank portions approximating to the long sides of alumina substrate 1.

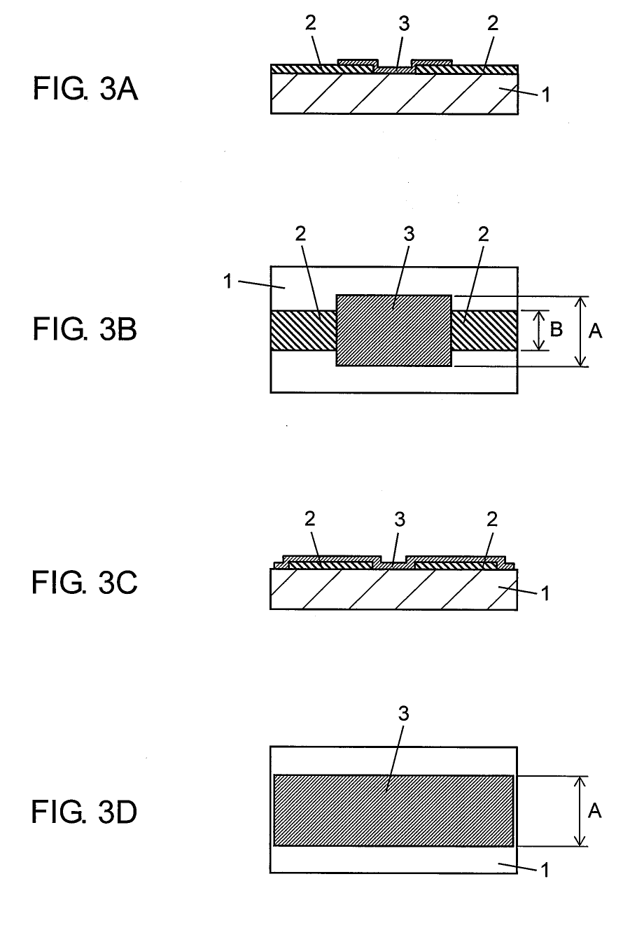

Next, as shown in FIGS. 3A and 3B, tungsten, material having a high melting point, is spattered between first electrodes 2 and partially overlaps first electrodes 2, thereby forming second electrode 3 made of thin film electrically connected to first electrodes 2. In this case, second electrode 3 may cover portions of first electrodes 2, or may entirely cover first electrodes 2, as shown in FIGS. 3C and 3D. Second electrode 3 is formed in a region where a gap (described later) is to be formed. Therefore, in order to reduce material cost of second electrode 3, and in order to extend the lifetime of a mask pattern for spatter used for forming second electrode 3, second electrode 3 is formed so as to cover portions of first electrodes 2, as shown in FIGS. 3A and 3B, in a range allowing second electrode 3 to securely adhere to alumina substrate 1 and first electrodes 2. The thermal expansion coefficient of tungsten contained in second electrode 3 ranges 4.3×10⁻⁶ to 4.5×10⁻⁶/K, and is close to the thermal expansion coefficient of alumina substrate 1 ranging from about 6.4×10⁻⁶ to 8.0×10⁻⁶/K, so that second electrode 3 may securely adhere to alumina substrate 1. A DC spattering apparatus of an in-line system is used as a spattering apparatus for forming second electrode 3. The film of the second electrode is formed for 30 to 60 minutes under the condition that the output is 3 kW, argon gas pressure ranges from 0.5 to 4.5 mmTorr (66 to 600 Pa). Width A of second electrode 3 is greater than width B of first electrodes 2, as shown in FIGS. 3B and 3D, thereby allowing second electrode 3 to securely adhere to alumina substrate 1.

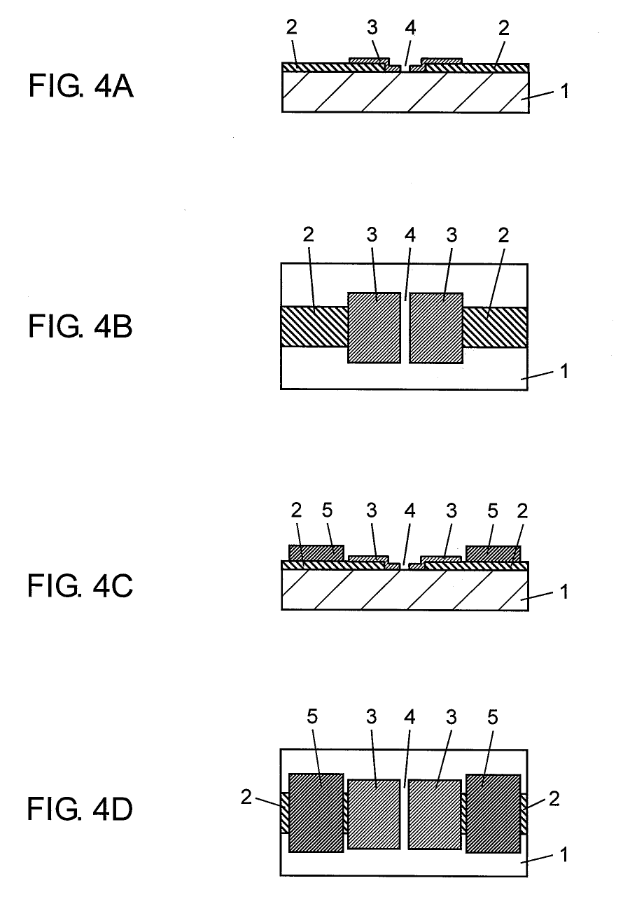

Next, as shown in FIGS. 4A and 4B, a substantially center portion of second electrode 3 is cut with UV laser, thereby forming gap 4 having a width of about 10 μm. Second electrode 3 is formed by mask-spattering tungsten having a high melting point to form a thin film, and therefore, has a small thickness. The UV laser having a relatively low power of 0.2 W, can form gap 4 reliably and accurately by physically cutting second electrode 3. This method prevents gap 4 from short-circuiting more than photolithography.

Next, as shown in FIGS. 4C and 4D, resin silver paste is printed in thicknesses ranging from 3 to 20 μm by a screen printing method so as to cover portions of first electrodes 2, and is dried at a temperature ranging from 100 to 200° C. for 5 to 15 minutes, thereby providing a pair of upper electrodes 5

Next, as shown in FIGS. 5A and 5B, resin silver paste is printed on a lower surface of alumina substrate 1 in a thickness ranging from 3 to 20 μm by a screen printing method, and is dried at a temperature ranging form 100 to 200° C. for 5 to 15 minutes, thereby providing a pair of lower electrodes 6. The width of the portion of each lower electrode 6 connected with the short side of alumina substrate 1 is narrower than that of the other portion of each lower electrode 6. In the individual alumina substrate, the lower electrodes have T-shapes at both ends of the substrate. This structure allows alumina substrate 1 to be cut along the short side of alumina substrate 1, a primary dividing line, by dicing without burrs produced when alumina substrate 1 is divided into strip-like substrates. Hence, the individual ESD protector has accurate dimensions accuracy even having a small size.

Next, as shown in FIGS. 5C and 5D, over-voltage protective material paste is printed in a thickness ranging from 5 to 50 μm by a screen printing method so as to cover gap 4 and portions of second electrodes 3, and is dried at about 150° C. for 5 to 15 minutes, thereby forming over-voltage protective layer 7. The over-voltage protective material paste forming over-voltage protective layer 7 is produced by adding appropriate organic solvent to a mixture of spherical metal powder that is made of one of Ni, Al, Ag, Pd, and Cu and that has a average grain size ranging from 0.3 to 10 μm and silicone resin, such as methyl silicone, and by kneading and dispersing them with three roll mills.

Next, as shown in FIG. 5E, paste for an intermediate layer is printed in a thickness ranging from 5 to 50 μm by a screen printing method so as to cover over-voltage protective layer 7. At this moment, the paste is printed in the same size as over-voltage protective layer 7 over gap 4 so as to entirely cover over-voltage protective layer 7, and is dried at about 150° C. for 5 to 15 minutes, thereby forming intermediate layer 8. The paste for forming intermediate layer 8 is produced by adding appropriate organic solvent to a mixture of insulator powder that is made of Al₂O₃, SiO₂, MgO, or mixture of these oxides and that has an average grain size ranging from 0.3 to 10 μm and silicone resin, such as methyl silicone, and by kneading and dispersing them with three roll mills. In order to obtain sufficient resistance to static electricity, the sum of thicknesses of over-voltage protective layer 7 and intermediate layer 8 after drying is 30 μm or more. When over-voltage protective layer 7 has a sufficiently large thickness and provides a predetermined resistance to statis electricity, intermediate layer 8 may not necessarily be formed.

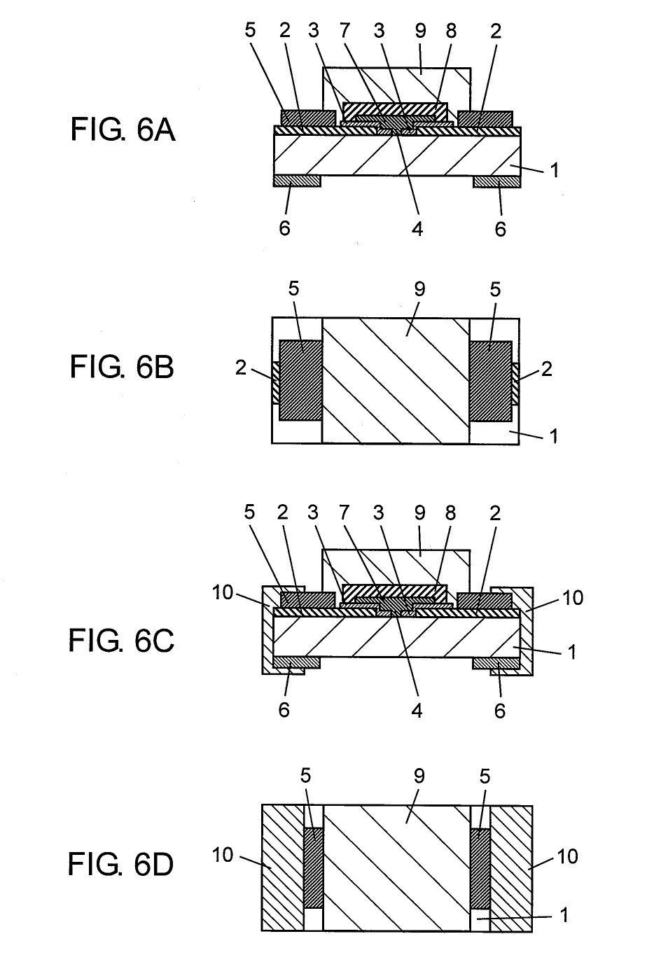

Next, as shown in FIGS. 6A and 6B, protective resin paste made of epoxy resin, phenol resin, or the like is printed by the screen printing method so as to entirely cover intermediate layer 8 and to allow respective portions of upper electrodes 5 to be exposed at both ends of the substrate, and is dried at about 150° C. for 5 to 15 minutes. Then, the protective resin paste is hardened at a temperature ranging from 150 to 200° C. for 15 to 60 minutes, thereby forming protective resin layer 9. The thickness of protective resin layer 9 after the drying ranges from 15 to 35 μm.

Next, as shown in FIGS. 6C and 6D, both ends of alumina substrate 1 are coated with resin silver paste, thereby forming edge electrodes 10 electrically connected to first electrodes 2, upper electrodes 5, and lower electrodes 6, respectively. Specifically, the strip-like substrate is produced by dicing the aggregated alumina substrate along the short side of alumina substrate 1 corresponding to the primary dividing line (not shown). Edge electrodes 10 are formed on edge surfaces of the strip-like substrate in the above-mentioned method.

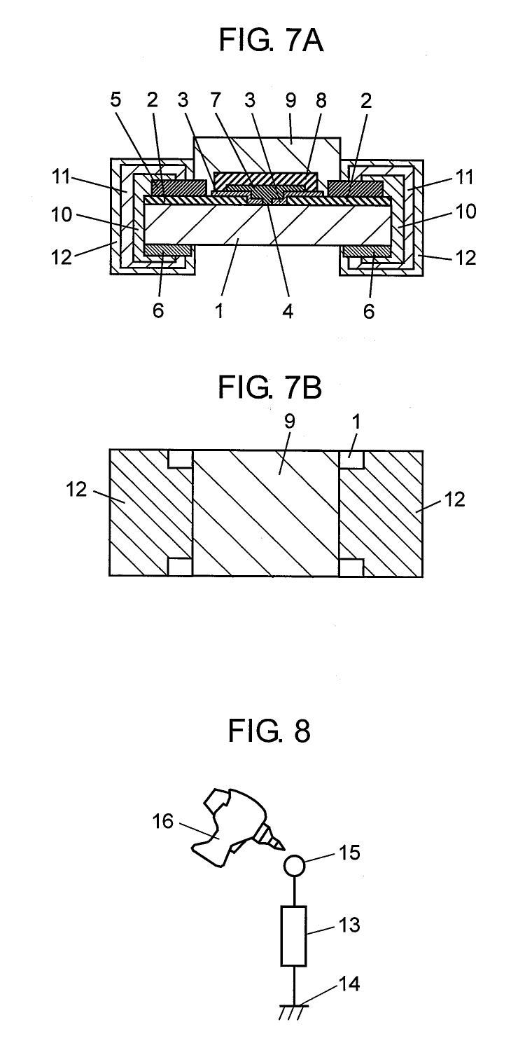

Finally, as shown in FIGS. 7A and 7B, nickel-plated layer 11 and tin-plated layer 12 are formed so as to cover edge electrodes 10. The individual substrate is produced by dividing the strip-like substrate along the long side of alumina substrate 1 corresponding to a secondary dividing line (not shown). Nickel-plated layer 11 and tin-plated layer 12 are formed on the edge surfaces of the individual substrate by a barrel plating method, thereby providing the ESD protector according to Embodiment 1.

The ESD protector according to Embodiment 1 manufactured by the above method is electrically opened because the silicone resin of over-voltage protective layer 7 covering gap 4 between second electrodes 3 has an insulating property in an ordinary usage (at a rated voltage). When a high voltage, such as an electrostatic pulse, is applied, a discharge current flows between the metal particles across the silicone resin in over-voltage protective layer 7, extremely reducing the impedance of over-voltage protective layer 7. Utilizing this phenomenon, the ESD protector according to Embodiment 1 bypasses an abnormal voltage, such as an electrostatic pulse or surge, to the ground.

The ESD protector according to Embodiment 1 having the above structure was tested. As shown in FIG. 8, one terminal of ESD protector 13 according to Embodiment 1 is connected to ground 14, and electrostatic test gun 16 contacts electrostatic pulse applying section 15 connected to the other terminal to apply an electrostatic pulse under the condition that a discharge resistance was 330Ω, a discharge capacitance was 150 pF, and the applied voltage was 8 kV.

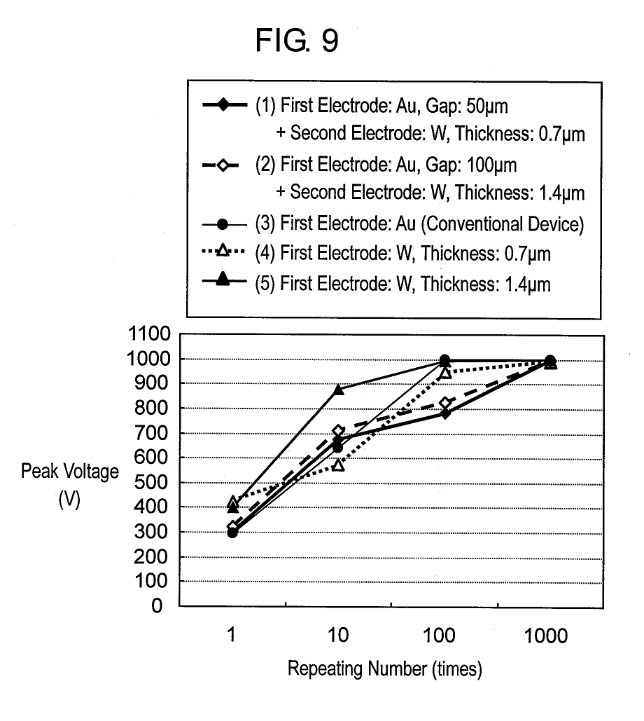

FIG. 9 is a graph showing a result of the electrostatic test shown in FIG. 8. In this graph, the horizontal axis represents the repeating number of times the electrostatic pulse was repetitively applied, and the vertical axis represents the peak voltage at that time. The increase of the peak voltage shows the degradation of the electrodes.

FIG. 9 shows the test results of ESD protectors under the following conditions:
(1) an ESD protector including first electrodes 2 made of gold and second electrodes 3 made of tungsten having a thickness of 0.7 μm, and having a gap width of 50 μm;

(2) an ESD protector including first electrodes 2 made of gold and second electrodes 3 made of tungsten having a thickness of 1.4 μm, and having a gap width of 100 μm;
(3) an ESD protector including first electrodes 2 made of resinate gold (a conventional ESD protector);

(4) an ESD protector including first electrodes 2 made of tungsten and having a thickness of 0.7 μm; and
(5) an ESD protector including first electrodes 2 made of tungsten and having a thickness of 1.4 μm.

As shown in FIG. 9, when the number of times is one, the peak voltages of the ESD protector having condition (4) and the ESD protector having condition (5) are high since the resistance of first electrodes 2 is high. When the number of times is 10, the peak voltages of the ESD protector having condition (1) and the ESD protector having condition (2) are substantially identical to that of the ESD protector (conventional art) having condition (3). The peak voltages of the ESD protector having condition (4) and the ESD protector having condition (5) largely vary and become unstable. When the number of times is 100 or more, the peak voltage of the ESD protector (the conventional ESD protector) having condition (3) is 1000V, and the ESD protector entirely breaks. The peak voltages of the ESD protector having condition (1) and the ESD protector having condition (2), however, are lower, and have stabler characteristics to suppressing electrostatic discharge (ESD). Second electrodes 3 made of material having a high melting point is thinner than first electrodes 2 and have gap 4 between second electrodes 3, thereby providing the ESD protector with resistant to the repetitive application of static electricity.

According to Embodiment 1, intermediate layer 8 covers over-voltage protective layer 7, and intermediate layer 8 and over-voltage protective layer 7 are entirely covered with protective resin layer 9. This structure prevents the insulating property of protective resin layer 9, the outermost layer, from deteriorating when an electrostatic pulse is applied.

According to Embodiment 1, upper electrodes 5 overlapping partially first electrodes 2 prevent solder flowing in a clearance between tin-plated layer 12 and protective resin layer 9 during the mounting of the ESD protector from directly contacting first electrodes 2. Upper electrodes 5 contact the solder and prevent the solder from eroding first electrodes 2 and increasing the resistance of the first electrodes to deteriorate the effect for suppressing static electricity, thus providing the ESD protector with a stable static electricity suppressing effect.

According to Embodiment 1, first electrodes 2 forming connection electrodes are made of material mainly containing gold, and second electrodes 3 positioned between first electrodes 2 are made of material mainly containing tungsten. Second electrodes 3 may be made of material mainly containing molybdenum instead of tungsten, providing the same effects as Embodiment 1.

According to Embodiment 1, first electrodes 2 forming connection electrodes are made of material mainly containing gold, and second electrodes 3 between first electrodes 2 are made of material mainly containing tungsten. This description means that first electrodes 2 and second electrodes 3 made of gold and tungsten may contain impurities, and does not mean that first electrodes 2 and second electrodes 3 are made of alloy.

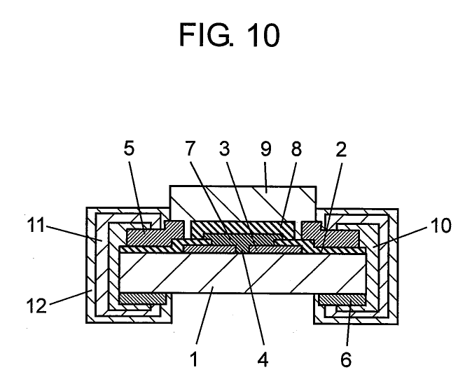

According to Embodiment 1, first electrodes 2 are formed at both ends of alumina substrate 1, and then, second electrodes 3 are formed to cover portions of first electrodes 2. This order may be reversed. FIG. 10 is a sectional view of another ESD protector in accordance with Embodiment 1 of the present invention. In FIG. 10, second electrodes 3 are formed on a substantially center portion of alumina substrate 1, and then a pair of first electrodes 2 are formed at both ends of alumina substrate 1 so as to cover portions of second electrodes 3, providing the same effects.

The thickness of first electrodes 2 after firing ranges from 2 to 20 μm, preferably from 2 to 10 μm. The thicker first electrodes 2 are, the lower the resistance of the electrodes is. If the thickness is excessively large, however, a step produced between the first electrodes and an area in which no electrode is large. This step may prevent over-voltage protective layer 7 and intermediate layer 8 which are formed on the step from being formed uniformly.

### Exemplary Embodiment 2

An electrostatic discharge (ESD) protector and its manufacturing method in accordance with Exemplary Embodiment 2 will be described below with reference to the accompanying drawings. The ESD protector according to Embodiment 2 includes second electrodes 3 made of material mainly containing nickel. Except for this, the ESD protector has a structure similar to that of the ESD protector according to Embodiment 1. The section of the ESD protector is illustrated in FIG. 1, and processes for manufacturing the ESD protector are illustrated in FIGS. 2A to 7B. The ESD protector is tested by the same method as the ESD protector according to Embodiment 1 shown in FIG. 8. Therefore, their description regarding the section, the manufacturing process, and the test method will be omitted.

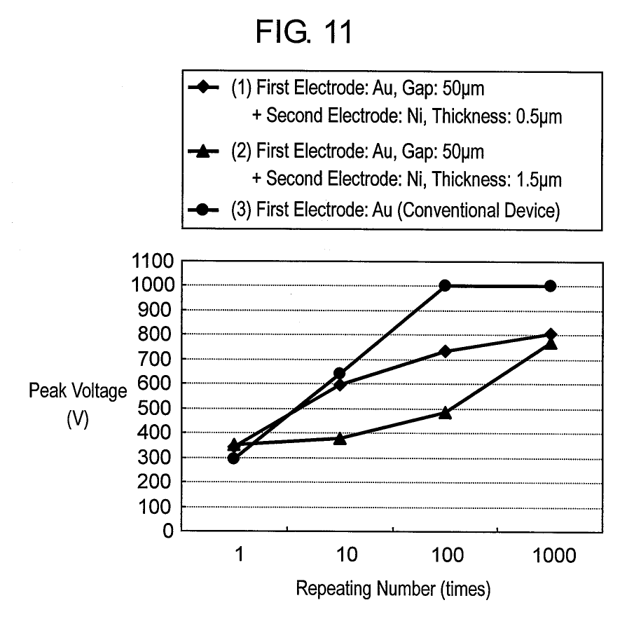

FIG. 11 is a graph showing a result of the electrostatic test of the ESD protector in accordance with Embodiment 2 of the present invention. In the graph of FIG. 11, the horizontal axis represents the number of repeating time an electrostatic pulse is applied, and the vertical axis represents a peak voltage at that time. The increase of the peak voltage shows the degradation of the electrodes.

FIG. 11 shows test results of the ESD protectors and the conventional ESD protector having the following conditions:
(1) an ESD protector including first electrodes 2 made of gold and second electrodes 3 made of nickel having a thickness of 0.5 μm, and having a gap width of 50 μm;
(2) an ESD protector including first electrodes 2 made of gold and second electrodes 3 made of nickel having a thickness of 1.5 μm, and having a gap width of 50 μm; and
(3) an ESD protector including first electrodes 2 made of resinate gold.

As shown in FIG. 11, when the repeating number is one, the peak voltages of three ESD protectors are not different from each other very much. When the repeating number is 10, the peak voltage of the ESD protector having condition (2) is lower than the peak voltages of two other ESD protectors, and thus, the ESD protector having condition (2) is preferable. When the repeating number is 100 or more, the peak voltage of the ESD protector (the conventional ESD protector) having condition (3) is 1000V and entirely breaks. The peak voltages of the ESD protector having condition (1) and the ESD protector having condition (2) are lower than the peak voltage of the conventional ESD protector, and thus, the ESD protectors having conditions (1) and (2) have stabler characteristics for suppressing electrostatic discharge (ESD) than the conventional ESD protector. The ESD protectors having conditions (1) and (2) have resistance to repetitive application of static electricity. Thus, the ESD protectors have more sufficient characteristic than that of the ESD protector according to Embodiment 1 including tungsten thin film as the second electrodes.

A reason for the above is considered as follows. The melting point of nickel is 1455° C., which is lower than the melting point of tungsten, 3407° C., and higher than the melting point of gold, 1064° C. The electrodes made of nickel are expected to have heat resistance larger than that of the conventional ESD protector including the electrodes having a single-layer structure made of resinate gold. Tungsten has an extremely high melting point, so that it has high heat resistance. However, a thin film made of tungsten can be oxidized easily, and the oxidizing reaction increases the resistance of the tungsten thin film. The nickel thin film has an oxide film formed strongly and densely on its surface, and the oxidizing reaction does not progress to inside, hence allowing the resistance of the thin film to be small stably. Thus, the ESD protector is provided with a low peak voltage and a stable suppressing characteristic of electrostatic discharge (ESD) even after repetitive application of electrostatic discharge. In order to confirm that the tungsten thin film is more easily oxidized than the nickel thin film, the peak voltage of the ESD protectors before a humidity test was compared with that after the humidity test. The ESD protector including first electrodes 2 made of gold and second electrodes 3 made of tungsten had a peak voltage after the humidity test was 50 to 100% higher than that before the humidity test. The ESD protector including first electrodes 2 made of gold and second electrodes 3 made of nickel has a peak voltage after the humidity test was substantially equal to that before the humidity test.

The specific resistance of nickel is 6.8 μΩcm, which is slightly larger than the specific resistance, 5.5 μΩcm, of tungsten. However, nickel can hardly be oxidized, maintaining the small resistance. Therefore, as shown in FIG. 11, the ESD protector employing nickel can obtain more sufficient characteristic than the ESD protector employing tungsten.

According to Embodiment 2, intermediate layer 8 covers over-voltage protective layer 7, and intermediate layer 8 and over-voltage protective layer 7 are entirely covered with protective resin layer 9, similarly to Embodiment 1. Protective resin layer 9, the outermost layer, has an insulating property prevented from deteriorating even when an electrostatic pulse is applied.

According to Embodiment 2, upper electrodes 5 overlapping portions of first electrodes 2 prevent solder flowing in a clearance between tin-plated layer 12 and protective resin layer 9 during mounting to the ESD protector from directly contacting first electrodes 2. Upper electrodes 5 contact the solder and prevent the solder from eroding first electrodes 2 and increasing the resistance of the first electrodes to deteriorate the effect for suppressing static electricity, thus providing the ESD protector with a stable effect suppressing static electricity.

According to Embodiment 2, first electrodes 2 forming connection electrodes are made of material mainly containing gold, and second electrodes 3 between first electrodes 2 are made of material mainly containing nickel. This description means that first electrodes 2 and second electrodes 3 made of gold and nickel may contain impurities, and does not mean that first electrodes 2 and second electrodes 3 are made of alloy.

According to Embodiment 2, first electrodes 2 are formed at both ends of alumina substrate 1, and then, second electrodes 3 are formed to cover portions of first electrodes 2. This order may be reversed. As shown in FIG. 10, second electrodes 3 are formed on a substantially center portion of alumina substrate 1, and then a pair of first electrodes 2 are formed at both ends of alumina substrate 1 so as to cover portions of second electrodes 3, providing the same effects.

### Exemplary Embodiment 3

An electrostatic discharge (ESD) protector and its manufacturing method in accordance with Exemplary Embodiment 3 will be described below with reference to accompanying drawings.

The ESD protector according to Embodiment 3 includes second electrodes 3 made of material mainly containing aluminum. Except for this, the ESD protector has a structure similar to that of the ESD protector according to Embodiment 1. The section of the ESD protector is illustrated in FIG. 1, and processes for manufacturing the ESD protector are illustrated in FIGS. 2A to 7B. The ESD protector is tested by the same method as the ESD protector according to Embodiment 1 shown in FIG. 8. Therefore, their description regarding the section, the manufacturing process, and the test method will be omitted.

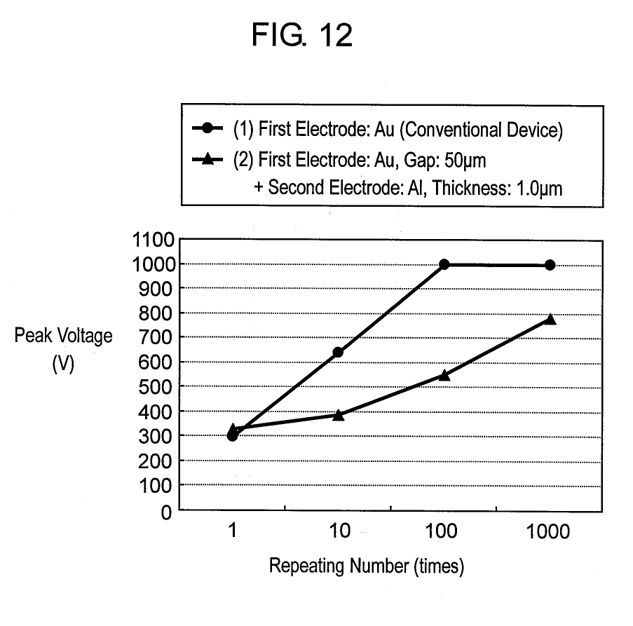

FIG. 12 is a graph showing a result of the electrostatic test of the ESD protector in accordance with Embodiment 3 of the present invention. In the graph of FIG. 12, the horizontal axis represents the number of repeating time an electrostatic pulse is applied, and the vertical axis represents a peak voltage at that time. The increase of the peak voltage shows the degradation of the electrodes.

FIG. 12 shows test results of the ESD protectors having the following conditions:
(1) an ESD protector including first electrodes 2 made of gold and second electrodes 3 made of aluminum having a thickness of 1.0 μm, and having a gap width of 50 μm; and
(2) an ESD protector including first electrodes 2 made of resinate gold (a conventional ESD protector).

As is clear from FIG. 12, when the repeating number is one, the peak voltages of the two ESD protectors are not different from each other very much. When the repeating number is 10 or later, the peak voltage of the ESD protector having condition (1) is preferably lower than that of the ESD protector (the conventional ESD protector) having condition (2).

A reason for the above is considered as follows. The melting point of aluminum is 660° C., which is lower than the melting point of tungsten, 3407° C., and the melting point of gold, 1064° C. However, the surface of the film of aluminum forming second electrodes 3 is covered with a dense film of aluminum oxide, and aluminum oxide has a high melting point, 2020° C. Therefore, the ESD protector having condition (1) has higher heat resistance than the conventional ESD protector including the connection electrodes made of only resinate gold. Oxidizing reaction occurs in the interface between alumina substrate 1 and second electrodes 3 made of the film of aluminum to produce aluminum oxide. The aluminum oxide and aluminum are not clearly separated from each other, and the composition changes continuously. Therefore, alumina substrate 1 is adhered securely to second electrodes 3. First electrodes 2 are made of a thick material mainly containing gold, and the surfaces of the electrodes are hardly oxidized and have appropriate roughness. Therefore, aluminum oxide that disturbs the electric conduction exists little in the interface between first electrodes 2 and second electrodes 3, and hence high electric conduction is secured between first electrodes 2 and second electrodes 3.

The specific resistance of aluminum is 2.6 μcm, which is lower than a half of the specific resistance 5.5 μΩcm of tungsten. Second electrodes 3 can obtain a sufficient characteristic shown in FIG. 12 due to both the low resistance of aluminum and the high heat resistance of aluminum oxide.

According to Embodiment 3 of the present invention, intermediate layer 8 covers over-voltage protective layer 7, and intermediate layer 8 and over-voltage protective layer 7 are entirely covered with protective resin layer 9, similarly to Embodiment 3. Therefore, the insulating property of protective resin layer 9, the outermost layer, is prevented from deteriorating when an electrostatic pulse is applied.

According to Embodiment 3, upper electrodes 5 overlapping portions of first electrodes 2 prevent solder flowing in a clearance between tin-plated layer 12 and protective resin layer 9 during mounting to the ESD protector from directly contacting first electrodes 2. Upper electrodes 5 contact the solder and prevent the solder from eroding first electrodes 2 and increasing the resistance of the first electrodes to deteriorate the effect for suppressing static electricity, thus providing the ESD protector with a stable static electricity suppressing effect.

According to Embodiment 3, first electrodes 2 forming connection electrodes are made of material mainly containing gold, and second electrodes 3 between first electrodes 2 are made of material mainly containing aluminum. This description means that first electrodes 2 and second electrodes 3 made of gold and aluminum may contain impurities, and does not mean that first electrodes 2 and second electrodes 3 are made of alloy.

According to Embodiment 3, first electrodes 2 are formed at both ends of alumina substrate 1, and then, second electrodes 3 are formed to cover portions of first electrodes 2. This order may be reversed. As shown in FIG. 10, second electrodes 3 are formed on a substantially center portion of alumina substrate 1, and then a pair of first electrodes 2 are formed at both ends of alumina substrate 1 so as to cover portions of second electrodes 3, providing the same effects.

According to the present invention, second electrodes 3 adhering securely to alumina substrate 1 as the insulating substrate provides a narrow gap having a width of about 10 μm reliably and accurately between the second electrodes. Second electrodes 3 prevent the connection electrodes from peeling off from alumina substrate 1, allowing the ESD protector to be resistant to repetitive application of static electricity, to reduce a peak voltage, and to have a stable suppressing characteristic of electrostatic discharge (ESD).

According to the present invention, first electrodes 2 are made of material mainly containing gold, and second electrodes 3 are made of thin film material mainly containing tungsten or molybdenum. First electrodes 2 forming connection electrodes are made of material mainly containing gold, preventing the ESD protector from being corroded and allowing the ESD protector to have high resistance to sulfur. Second electrodes 3 are made of thin film material mainly containing tungsten or molybdenum. Tungsten and molybdenum have high melting points. Therefore, thin second electrodes 3 are made of material mainly containing tungsten or molybdenum, allowing gap 4 to be formed between second electrodes 3 by cutting second electrodes 3 with laser having a relatively low power. Thus, the ESD protector reduces a peak voltage and has a stable characteristic to suppress electrostatic discharge (ESD).

The thermal expansion coefficient of tungsten ranges from 4.3×10⁻⁶ to 4.5×10⁻⁶/K, and the thermal expansion coefficient of molybdenum is 5.1×10⁻⁶/K. These thermal expansion coefficients are close to the thermal expansion coefficient of alumina substrate 1 ranging from 6.4×10⁻⁶ to 8.0×10⁻⁶/K. Second electrodes 3 adhere securely to alumina substrate 1, and prevent the connection electrodes from damage due to heat produced by static electricity repetitively applied. Thus, the ESD protector reduces a peak voltage and has a stable characteristic suppressing electrostatic discharge (ESD).

According to the present invention, first electrodes 2 are made of material mainly containing gold, and second electrodes 3 are made of thin film material mainly containing nickel. First electrodes 2 forming connection electrodes are made of material mainly containing gold, preventing the ESD protector from being corroded and allowing the ESD protector to have high resistance to sulfur. Second electrodes 3 are made of thin film mainly containing nickel. Nickel has a high melting point and a high heat resistance. Therefore, second electrodes 3 made of the thin film mainly containing nickel allows gap 4 to be formed between second electrodes 3 by cutting with laser having a relatively low power and provide the connection electrodes with high heat resistance. A surface oxide film is formed strongly and densely on nickel, and prevents oxidation reaction from progressing to inside, maintaining the low resistance of second electrodes 3 mainly made of nickel stably. Thus, the ESD protector reduces a peak voltage and has a stable characteristic suppressing electrostatic discharge (ESD).

According to the present invention, second electrodes 3 are made of thin film material mainly containing aluminum. First electrodes 2 forming connection electrodes are made of material mainly containing gold, preventing the ESD protector from being corroded and allowing the ESD protector to have high resistance to sulfur. Second electrodes 3 are made of thin film mainly containing aluminum. Second electrodes 3 made of the thin film mainly containing nickel allows gap 4 to be formed between second electrodes 3 by cutting with laser having a relatively low power. Aluminum oxide is provided at the interface between alumina substrate 1 and thin film mainly containing aluminum. The thermal expansion coefficient of second electrode 3 is close to the thermal expansion coefficient of alumina substrate 1 at the interface between second electrodes 3 and alumina substrate 1, hence allowing second electrode 3 to adhere securely to alumina substrate 1. Thin film mainly made of aluminum has aluminum oxide formed strongly and densely on the film, and prevents oxidation reaction from progressing to inside, maintaining the low resistance of second electrodes 3 mainly made of aluminum stably. Thus, the ESD protector reduces a peak voltage and has a stable characteristic suppressing electrostatic discharge (ESD).

In the manufacturing method according to the present invention, thick first electrodes 2 made of material having a low specific resistance are formed on the upper surface of alumina substrate 1, thereby reducing the resistance of first electrodes 2 forming the connection electrodes. This reduces heat produced by the current flowing due to static electricity applied. Thin second electrodes 3 mainly made of material having a high melting point are formed between first electrodes 2 and are electrically connected to first electrodes 2, and provide a gap between second electrodes 3. This structure prevents the electrodes from damage due to application of static electricity, and provides a narrow gap having a width of about 10 μm reliably and accurately between second electrodes 3. Thus, the ESD protector is resistant to repetitive application of static electricity, reduces a peak voltage, and has a stable characteristic to suppressing electrostatic discharge (ESD).

In the manufacturing method according to the present invention, the thick first electrodes made of material having a low specific resistance are formed on the upper surface of alumina substrate 1, thereby reducing the resistance of first electrodes 2 forming the connection electrodes. The specific resistance is preferably equal to or less than that of gold resinate paste, that is, preferably 1×10⁻² Ωcm or lower. This reduces heat produced by the current flowing due to static electricity applied. Thin second electrodes 3 made of material adhering to alumina substrate 1 are formed between first electrodes 2, are electrically connected to first electrodes 2, and provides gap 4 between second electrodes 3. This provides a narrow gap having a width of about 10 μm reliably and accurately between second electrodes 3. Thin second electrodes 3 having high adhesiveness to alumina substrate 1 prevent the connection electrodes from being peeled of from alumina substrate 1. Therefore, the ESD protector is resistant to repetitive application of static electricity, reduces a peak voltage, and has a stable characteristic to suppressing electrostatic discharge (ESD). The small film thickness means that the film thickness is less than that of general thick electrodes used for a normal resistor, that is, preferably about 2 μm or less.

In the manufacturing method according to the present invention, thick first electrodes 2 forming the connection electrodes are formed with the material mainly containing gold by a printing and firing technology, providing the ESD protector that is hardly corroded and resistant to sulfur. Thin second electrodes 3 are formed by spattering the material mainly containing tungsten or molybdenum, and gap 4 is formed by cutting second electrodes 3 with a laser. Tungsten and molybdenum have high melting points. Therefore, when thin second electrodes 3 are formed using the material mainly containing tungsten or molybdenum and gap 4 is formed between second electrodes 3, second electrodes 3 can be cut with laser having relatively low power. Thus, the ESD protector reduces a peak voltage and has a stable characteristic to suppressing electrostatic discharge (ESD).

In the manufacturing method according to the present invention, thick first electrodes 2 forming the connection electrodes are formed with the material mainly containing gold by the printing and firing technology, so that the ESD protector is hardly corroded and resistant to sulfur. Thin second electrodes 3 are formed by spattering the material mainly containing nickel, and the gap is formed by cutting second electrodes 3 with laser. Therefore, in the case that thin second electrodes 3 are formed with the material mainly containing nickel, and that the gap is formed between second electrodes 3, second electrodes 3 can be cut with laser having a relatively low power. Nickel has a high melting point, a surface oxide film is formed strongly and densely on nickel, and oxidation reaction does not progress to the inside of nickel, so that the resistance of second electrodes 3 mainly made of nickel is stably low. Thus, the ESD protector reduces a peak voltage and has a stable characteristic to suppressing electrostatic discharge (ESD).

In the manufacturing method according to the present invention, thick first electrodes 2 forming the connection electrodes are made of the material mainly containing gold. Therefore, the ESD protector is hardly corroded and is resistant to sulfur. Second electrodes 3 are formed by spattering the material mainly containing aluminum, so that second electrodes 3 can be cut with laser having a relatively low power in order to form the gap between second electrodes 3. A thin material mainly made of aluminum is formed by spattering, and aluminum oxide exists in a part of the thin film material contacting the alumina substrate. Hence, the thermal expansion coefficient of second electrodes 3 is close to the thermal expansion coefficient of alumina substrate 1 ranging from 6.4×10⁻⁶ to 8.0×10⁻⁶/K in the part between alumina substrate 1 and second electrodes 3. Therefore, second electrodes 3 adhere securely to alumina substrate 1. A thin film of aluminum oxide having high heat resistance is formed strongly and densely on the surfaces of second electrodes 3, thus preventing the oxidation reaction from progressing to inside of the film. Therefore, the resistance of second electrodes 3 mainly made of aluminum is stably low. Thus, the ESD protector reduces a peak voltage and has a stable characteristic to suppress electrostatic discharge (ESD).

The melting points of tungsten, molybdenum, nickel, gold, and aluminum are 3407° C., 2620° C., 1455° C., 1064° C., and 660° C., respectively. Metals effective as a material having a high melting point are metals having a melting point of nickel or higher. In other words, the melting points of the materials having a high melting point according to the present invention are about 1400° C. or higher.

High adhesiveness of the metal employed to the alumina substrate is caused by the fact that the thermal expansion coefficient of the metal is close to that of the alumina substrate. The thermal expansion coefficient of the tungsten ranges from 4.3×10⁻⁶ to 4.5×10⁻⁶/K. The thermal expansion coefficient of molybdenum is 5.1×10⁻⁶/K. Both the thermal expansion coefficients are close to the thermal expansion coefficient of alumina substrate 1 ranging from 6.4×10⁻⁶ to 8.0×10⁻⁶/K. Therefore, metal having its thermal expansion coefficient ranging from 4.3×10⁻⁶ to 8.0×10⁻⁶/K adheres securely to the alumina substrate.

The insulating substrate is required to have a low dielectric constant and to hardly fire, preferably has a thermal expansion coefficient close to that of the second electrodes. The insulating substrate is not limited to alumina substrate 1, and may be made of aluminum nitride, mulite-silica based ceramic, or borate ceramic.

### INDUSTRIAL APPLICABILITY

An electrostatic discharge (ESD) protector according to the present invention reduces heat produced in first electrodes forming connection electrodes and prevents the first electrodes from damage, and allows the width gap between second electrodes to be narrow and accurate. Thus, the ESD protector has resistant to repetitive application of static electricity, reduces a peak voltage applied to the ESD protector, and has stable characteristic to suppress electrostatic discharge (ESD). The ESD protector is applicable especially to a fine ESD protector for protecting an electronic apparatus from static electricity.

1. An electrostatic discharge (ESD) protector comprising:
an insulating substrate;
a pair of first electrodes provided on an upper surface of the insulating substrate;
a pair of second electrodes partially overlap the pair of first electrodes and electrically connected to the pair of first electrodes, respectively;
a gap provided between the pair of second electrodes; and
an over-voltage protective layer covering at least the gap, wherein
the pair of first electrodes are made of material having a low specific resistance, and
the pair of second electrodes are thinner than the pair of first electrodes.

2. The ESD protector according to claim 1, wherein the second electrodes are made of material with a high melting point.

3. The ESD protector according to claim 2, wherein the first electrodes are made of thin film material mainly containing gold, and the second electrodes are made of material mainly containing nickel.

4. The ESD protector according to claim 1, wherein the first electrodes are made of thin film material mainly containing gold, and the second electrodes are made of material mainly containing tungsten or molybdenum.

5. The ESD protector according to claim 1, wherein the specific resistance is 1×10⁻² Ωcm or lower, a thickness of the first electrodes is 2 μm or greater, and a thickness of the second electrodes is less than 2 μm.

6. The ESD protector according to claim 1, wherein the insulating substrate is an alumina substrate, and the second electrodes are made of metal having a thermal expansion coefficient ranging from 4.3×10⁻⁶ to 8.0×10⁻⁶/K.

7. The ESD protector according to claim 1, wherein the first electrodes are made of material mainly containing gold, and the second electrodes are made of thin film that mainly contains aluminum and that has film of aluminum oxide on a surface of the thin film.

8. A method of manufacturing an electrostatic discharge (ESD) protector, comprising:
forming a pair of first electrodes made of material having a low specific resistance on an upper surface of an insulating substrate;
forming second electrodes between the pair of first electrodes, the second electrodes being thinner than the pair of first electrodes, the second electrodes being electrically connected to the first electrodes, respectively;
forming a gap between the second electrodes; and
forming an over-voltage protective layer covering at least the gap.

9. The method according to claim 8, wherein the second electrodes are made of material having a high melting point.

10. The method according to claim 8, wherein the first electrodes are made of material having a specific resistance of 1×10⁻² Ωcm or lower and having thicknesses of 2 μm or greater, and thicknesses of the second electrodes are less than 2 μm.

11. The method according to claim 8, wherein
the first electrodes are formed with material mainly containing gold by printing and firing,
the second electrodes are formed by spattering material mainly containing nickel, and
the gap is formed by cutting the second electrodes with laser.

12. The method according to claim 8, wherein the insulating substrate is an alumina substrate, and the second electrodes are made of metal having a thermal expansion coefficient ranging from 4.3×10⁻⁶ to 8.0×10⁻⁶/K.

13. The method according to claim 8, wherein
the first electrodes are formed with material mainly containing gold by printing and firing,
the second electrodes are formed by spattering material mainly containing tungsten or molybdenum, and
the gap is formed by cutting the second electrodes with laser.

14. The method according to claim 8, wherein
the first electrodes are formed with material mainly containing gold by printing and firing,
the second electrodes are formed by spattering material mainly containing aluminum, and
the gap is formed by cutting the second electrodes with laser.

15. The ESD protector according to claim 2, wherein the first electrodes are made of thin film material mainly containing gold, and the second electrodes are made of material mainly containing tungsten or molybdenum.
